(19) United States
(12) Patent Application Publication
(10) Pub. No.: US 2026/0331471 A1
(43) Pub. Date: Oct. 22, 2026

(54) A METHOD FOR PRODUCING A CARBON ENRICHED MATERIAL FROM LIGNIN

(71) Applicant: Stora Enso OYJ, Helsinki (FI)

(72) Inventors: Stephan Walter, Bochum (DE); Vilhelm Olsson, Täby (SE); Mats Lindström, Vanda (FI)

(73) Assignee: Stora Enso OYJ, Helsinki (FI)

(21) Appl. No.: 19/486,243

(22) PCT Filed: May 30, 2024
(86) PCT No.: PCT/IB2024/055248

§ 371 Date: Nov. 20, 2025

(30) Foreign Application Priority Data
Jun. 9, 2023 (SE) 2330272-2

(51) Int. Cl. H01M 4/38; C01B 32/05; H01M 4/36

(52) U.S. Cl. CPC H01M 4/38; C01B 32/05; H01M 4/364; C01P 2004/61; C01P 2004/62; C01P 2006/40

(57) ABSTRACT

The present invention relates to a method for producing a carbon enriched material, said method comprising the steps of: a) providing lignin; b) mixing the lignin with a recirculated carbon enriched material fraction to obtain a lignin-carbon mixture; c) forming an agglomerated lignin-carbon composite material comprising lignin, the recirculated carbon enriched material fraction and optionally at least one additive; d) subjecting the agglomerated lignin-carbon composite material to heat treatment at one or more temperatures in the range of from 300 to 1500 °C, wherein the heat treatment is carried out for a total time in the range of from 30 minutes to 10 hours, so as to obtain a carbon enriched material; e) milling the obtained carbon enriched material to so as to reduce the average particle size of the carbon enriched material, and to obtain at least a first fraction of a carbon enriched material, and a second fraction of a carbon enriched material; and f) recirculating at least a part of the first fraction obtained in step e) to step b).

### FIELD OF THE INVENTION

The present invention relates to a method for producing a carbon enriched material from lignin. The method involves a step of recirculating at least a part of the obtained carbon enriched material and mixing it with lignin at an earlier process stage prior to converting the lignin to a carbon enriched material. The present invention further relates to a negative electrode for a non-aqueous secondary battery comprising the obtained carbon enriched material as active material, and use of the obtained carbon enriched material as active material in a negative electrode of a non-aqueous secondary battery.

### BACKGROUND

Secondary batteries, such as lithium-ion batteries, are electrical batteries which can be charged and discharged many times, i.e. they are rechargeable batteries. In lithium-ion batteries, lithium ions flow from the negative electrode through the electrolyte to the positive electrode during discharge, and back when charging. Today, typically a lithium compound, in particular a lithium metal oxide such as lithium nickel manganese cobalt oxide (NMC) or alternatively a lithium iron phosphate (LFP) is utilized as material of the positive electrode and a carbon enriched material is utilized as material of the negative electrode.

Graphite (natural or synthetic graphite) is today utilized as material of the negative electrode in most lithium-ion batteries due to their high energy density and stable charge/discharge performance over time. An alternative to graphite is amorphous carbon materials, such as hard carbons (non-graphitizable amorphous carbons) and soft carbons (graphitizable amorphous carbons), which lack long-range graphitic order. Common to graphite and amorphous carbons is that the volume changes during charge and discharge are small. This results in a good mechanical stability of the electrode material and helps to maintain good cycling stability. Amorphous carbons can be used as sole active electrode materials or in mixtures with graphite. Hard carbons often have good charge/discharge rate performance which is desired for fast charging and high-power systems.

Amorphous carbons can be derived from lignin. Lignin is an aromatic polymer, which is a major constituent in e.g. wood and one of the most abundant carbon sources on earth. In recent years, with development and commercialization of technologies to extract lignin in a highly purified, solid and particularized form from the pulp-making process, it has attracted significant attention as a possible renewable substitute to primarily aromatic chemical precursors currently sourced from the petrochemical industry. Amorphous carbons derived from lignin are typically non-graphitizable, i.e. hard carbons. Hard carbon derived from lignin thus enables a more sustainable anode material option than the graphite typically used in secondary batteries today.

Today, the most commercially relevant source of lignin is kraft lignin, obtained from hardwood or softwood through the kraft process. The lignin can be separated from alkaline black liquor using for example membrane-or ultrafiltration. One common separation process is described in WO2006031175 A1. In this process lignin is precipitated from alkaline black liquor by addition of acid and then filtered off. The lignin filter cake is in the next step re-slurried under acidic conditions and washed prior to drying and pulverization.

One problem with using lignin as a precursor for a carbon enriched material is that direct use of lignin, in the form of a fine powder, is not suitable since it exhibits undesired thermoplastic behaviour. During thermal conversion of lignin powder into carbon enriched materials, lignin undergoes plastic deformation/melting, aggressive swelling and foaming. This severely limits the processability of lignin in an industrially relevant scale, in terms of equipment dimensioning and process throughput as well as need of intermediate processing.

Thus, there is still room for improvements of methods for producing a carbon enriched material from lignin. The method should avoid that lignin undergoes plastic deformation and melting, aggressive swelling and foaming during heating, as well as when converting lignin to a carbon enriched material. In addition, it should be possible to use the method in large-scale manufacturing. The waste of material during the method should be minimized to enable sustainable manufacturing.

### SUMMARY OF THE INVENTION

It is an object of the present invention to provide an improved method for producing a carbon enriched material, which method allows use of a renewable carbon source, and which method eliminates or alleviates at least some of the disadvantages of the prior art methods.

It is a further object of the present invention to provide a method that obtains an improved carbon enriched material starting from lignin, which carbon enriched material is suitable for use as active material in a negative electrode of a secondary battery, such as a lithium-ion battery.

It is a further object of the present invention to provide a method for producing a carbon enriched material from lignin, which method allows heat treatment of lignin while retaining shape and dimension of the lignin.

It is a further object of the present invention to provide a method for improving the thermal processability of lignin.

It is a further object of the present invention to provide a method for producing a carbon enriched material from lignin, which method is scalable and thus suitable for large-scale manufacturing.

It is a further object of the present invention to provide a method for producing a carbon enriched material from lignin, where the waste of material during the method is reduced, thus enabling a more sustainable method.

The above-mentioned object, as well as other objects as will be realized by the skilled person in light of the present disclosure, are achieved by the various aspects of the present disclosure.

According to a first aspect, the present invention relates to a method for producing a carbon enriched material, said method comprising the steps of:
a) providing lignin;
b) mixing the lignin with a recirculated carbon enriched material fraction so as to obtain a lignin-carbon mixture;
c) forming an agglomerated lignin-carbon composite material comprising the lignin, the recirculated carbon enriched material fraction and optionally at least one additive;
d) subjecting the agglomerated lignin-carbon composite material to heat treatment at one or more temperatures in the range of from 300 to 1500 °C, wherein the heat treatment is carried out for a total time in the range of from 30 minutes to 10 hours, so as to obtain a carbon enriched material;
e) milling the obtained carbon enriched material so as to reduce the average particle size of the carbon enriched material, and to obtain at least a first fraction of carbon enriched material, and a second fraction of carbon enriched material; and
f) recirculating at least a part of the first fraction obtained in step e) to step b).

It has surprisingly been found that the thermal processability of lignin is improved by mixing lignin with a carbon enriched material and agglomerating said mixture. The carbon enriched material is dispersed within the lignin matrix, thus forming an agglomerated lignin-carbon composite material. The carbon enriched material improves the thermal resistance of the agglomerated lignin-carbon composite material by reducing the melting/swelling behaviour of lignin upon heating, which in turn improves processability of lignin on an industrial scale.

In the inventive method, the carbon enriched material mixed with lignin in step b) is recirculated from step e). After the milling step, at least two fractions of carbon enriched material are obtained. The at least two fractions of carbon enriched material may have different average particle sizes. By recirculating at least a part of the first fraction, it is ensured that the material waste of the process is minimized, and the yield is improved since carbon enriched material that may otherwise be discarded, such as carbon fines, is re-introduced into the process. This increases the profitability of the process, and it also decreases the environmental footprint. A more sustainable process is thus enabled. The second fraction of carbon enriched material may be further processed to a final product.

Typically, after milling, the fraction of carbon enriched material having an average particle size in the range of from 2 to 4 μm (i.e. the fine fraction) is discarded, whereas the fraction of carbon enriched material having a larger particle size is further processed to a final product. The discarded fraction may be used for example as an energy source or as replacement for carbon sourced from the petrochemical industry in various applications. By instead recirculating the fine fraction, the material waste of the process can be reduced, enabling a more sustainable process.

According to a second aspect, the present invention relates to a negative electrode for a non-aqueous secondary battery comprising the carbon enriched material obtainable by the method according to the first aspect.

According to a third aspect, the present invention relates to use of the carbon enriched material obtainable by the method according to the first aspect as active material in a negative electrode of a non-aqueous secondary battery.

### DETAILED DESCRIPTION

Step a) of the method according to the first aspect of the present invention involves providing lignin. It is intended throughout the present disclosure that the term “lignin” refers to any kind of lignin which may be used as the carbon source for making a carbon enriched material. Examples of said lignin are, but are not limited to, lignin obtained from vegetable raw material such as wood, e.g. softwood lignin, hardwood lignin, and lignin from annular plants. Also, the lignin can be chemically modified.

The lignin used in the present invention may be obtained through different extraction methods such as an organosolv process or a kraft process. The lignin may also be obtained from processes such as steam explosion or acidic pre-treatment followed by enzymatic hydrolysis. Preferably, the lignin used in the method of the present invention is kraft lignin, i.e. lignin obtained through the kraft process. The kraft lignin may be obtained from hardwood or softwood. The lignin may be obtained by the process disclosed in WO2006031175 A1 commonly referred to as the LignoBoost process. Typically, this process involves the steps of precipitation of lignin from alkaline black liquor by acidification; separation of the precipitated lignin; and re-slurrying the lignin under acidic conditions at least once. The obtained lignin may be dried and pulverized and thus provided as solid particles in powder form.

Preferably, the lignin has been purified or isolated before being used in the process according to the present invention. The lignin may be isolated from black liquor and optionally be further purified before being used in the process according to the present invention. The purification is typically such that the purity of the lignin is at least 90%, preferably at least 95%, more preferably at least 98%, based on the dry weight of the lignin. Thus, the lignin used according to the process of the present invention preferably contains less than 10%, preferably less than 5%, more preferably less than 2% impurities, such as cellulose, carbohydrates and inorganic compounds, based on the dry weight of the lignin.

In one embodiment, the lignin provided in step a) is in the form of a powder. The particle size distribution of the lignin in the form of a powder may be such that at least 80 wt-% of the particles have a diameter of less than 0.2 mm. The lignin in the form of a powder preferably has a moisture content of less than 45 wt %, or less than 25 wt %, or less than 10 wt %, or less than 8 wt %. In the context of the present invention, the diameter of a particle is the equivalent spherical diameter of the particle, if the particle is not spherical. The equivalent spherical diameter is the diameter of a sphere of equivalent volume.

In one embodiment, the lignin in step a) is provided in the form of a slurry. The term “slurry” as used herein refers to solid lignin particles suspended in a liquid, preferably an aqueous solution. For example, the lignin slurry provided in step a) may be a process stream in a lignin extraction method, such as the LignoBoost process. In embodiments where lignin is provided in the form of a slurry, the lignin must be dried prior to the agglomeration in step c). Once dried, the lignin may also be pulverized to obtain a lignin powder.

In one embodiment, the lignin provided in step a) is dissolved in a solution. The lignin may be dissolved in any suitable solvent in which lignin can be dissolved. For example, the lignin may be dissolved in black liquor. In embodiments where lignin is dissolved in a solution, the lignin must be isolated, e.g. by precipitation, from the solution and dried prior to the agglomeration in step c). Once dried, the lignin may also be pulverized to obtain a lignin powder.

The lignin provided in step a) may thus be either in solid form, or it may be dissolved. In step c) the lignin must be in the form of a powder.

Step b) of the method according to the first aspect of the present invention involves mixing the lignin with a recirculated carbon enriched material fraction to obtain a lignin-carbon mixture. The terms “recirculating” and “recirculated” as used herein refers to the process of collecting a fraction of produced material and introducing it at an earlier stage of the process. A recirculated carbon enriched material fraction has thus been produced by heat treatment at a later stage of the process, collected and recirculated such that it is introduced back into the process at an earlier stage, where it is mixed with lignin.

The term “lignin-carbon mixture” as used herein refers to a mixture of lignin and a carbon enriched material, where the carbon enriched material has been recirculated. The recirculated carbon enriched material fraction is in the form of a solid powder, and is mixed with lignin by any suitable mixing means. The mixing means may be selected depending on the form in which the lignin is provided. In the agglomerated lignin-carbon composite material it is important that the distribution of the carbon enriched material is uniform within the lignin matrix. This is in turn ensured by a sufficient mixing time and mixing speed during the step of mixing lignin with the recirculated carbon enriched material fraction.

The lignin-carbon mixture may be a powder mixture, or a mixture comprising a carbon enriched material dispersed in a solution, into which lignin is either dispersed or dissolved. The recirculated carbon enriched material fraction may thus be introduced back into the process at any suitable stage. For example, the recirculated carbon enriched material fraction may be introduced after lignin has been isolated and dried, i.e. outside of a lignin isolation plant, such as outside a LignoBoost plant. In another example, the recirculated carbon enriched material fraction may be introduced inside a lignin isolation plant, such as inside a LignoBoost plant. When introduced inside a lignin isolation plant, the recirculated carbon enriched material may be introduced into a process stream before or after isolation of lignin from black liquor.

In embodiments where lignin is provided in the form of a powder, the recirculated carbon enriched material fraction and the lignin powder may be mixed by dry mixing methods. By providing lignin in the form of a powder, mixing with the recirculated carbon enriched material fraction is simplified since both materials are in the dry state, and mixing takes place outside of a lignin isolation plant.

In embodiments where lignin is provided in the form of a slurry, the recirculated carbon enriched material fraction may be mixed with lignin by adding the carbon enriched material to the lignin slurry. The slurry will thus comprise both lignin particles and carbon enriched material particles. The lignin-carbon mixture may be separated from the solution by means of e.g. filtration, or any other suitable separation means. After that, the lignin-carbon mixture is dried prior to agglomeration in step c). In embodiments where the lignin slurry is a process stream in a LignoBoost plant, the recirculated carbon enriched material fraction may be introduced at any suitable stage in the process after precipitation of lignin from black liquor.

In embodiments where lignin is provided as dissolved in a solution, the recirculated carbon enriched material fraction may be mixed with lignin by adding the carbon enriched material to the solution comprising dissolved lignin. The solution will thus comprise dissolved lignin and dispersed carbon enriched material. Lignin must be isolated from the solution, e.g. by precipitation or any other suitable means, prior to agglomeration in step c). Once the lignin is in solid form, the lignin-carbon mixture may be separated from the solution by means of e.g. filtration, or any other suitable separation method. After that, the lignin-carbon mixture is dried prior to agglomeration in step c). In embodiments where the solution is black liquor, the recirculated carbon enriched material fraction must be introduced to black liquor prior to precipitation of lignin from the black liquor. For example, the carbon enriched material may be introduced to black liquor either before the black liquor is introduced into a LignoBoost plant, or when the black liquor has been introduced into a LignoBoost plant.

It may be advantageous to mix the recirculated carbon enriched material with lignin when lignin is in the form of a slurry or dissolved in a solution since the interactions between the carbon enriched material and lignin may be improved.

Step c) of the method according to the first aspect of the present invention involves forming an agglomerated lignin-carbon composite material comprising the lignin, the recirculated carbon enriched material fraction and optionally at least one additive.

The term “lignin-carbon composite” as used herein in phrases such as “agglomerated lignin-carbon composite material” and “thermally stabilized agglomerated lignin-carbon composite material”, refers to a composite comprising lignin and a carbon enriched material. The term “lignin-carbon composite” further refers to a material comprising essentially only lignin and carbon enriched material, such that at least 95 wt %, or at least 98 wt %, based on the dry weight of the lignin-carbon composite, of the lignin-carbon composite consists of lignin and carbon enriched material. The lignin-carbon composite may optionally also comprise small amounts, such as less than 5 wt %, or less than 2 wt %, of at least one additive. In the lignin-carbon composite, the carbon enriched material is uniformly dispersed within a lignin matrix.

The term “agglomerated lignin-carbon composite material” as used herein refers to macroscopic particles in turn comprising clustered smaller particles of lignin, with carbon enriched material particles dispersed within the lignin matrix. Optionally, small amounts of at least one additive may be present in the agglomerated lignin-carbon composite material.

The agglomerated lignin-carbon composite material comprises, based on the total weight of the agglomerated lignin-carbon composite material, from 1 to 50 wt %, or from 1 to 40 wt %, or from 1 to 30 wt %, or from 5 to 30 wt % of recirculated carbon enriched material; from 50 to 99 wt %, or from 60 to 99 wt %, or from 70 to 95 wt %, or from 70 to 99 wt % lignin; and optionally less than 5 wt %, or less than 2 wt % of at least one additive.

The agglomerated lignin-carbon composite material may have an average particle size in the range of from 0.05 to 5.0 mm, or from 0.05 to 1.0 mm, or from 0.2 to 1.0 mm, or from 0.2 to 5.0 mm or from 0.5 to 2.0 mm, or from 0.5 to 5.0 mm. The preferred average particle size is in the range of from 0.5 to 2.0 mm. In the present application, the average particle size is defined as the volume average particle size (Dᵥ₅₀). This value refers to the maximum particle size below which 50% of the volume of the sample exists. The particle size is in the context of the present invention taken to be the diameter of the particle. The particle size distribution may be determined using for example laser diffraction.

The agglomerated lignin-carbon composite material has a bulk density in the range of from 0.4 to 0.8g/cm³. The bulk density of the agglomerated lignin-carbon composite material is increased compared to the lignin-carbon mixture prior to forming the agglomerated material.

By forming an agglomerated lignin-carbon composite material, a more compact and hard material is achieved. Hard agglomerates are advantageous during subsequent processing since they can resist physical impact during processing. The interactions between particles, such as between lignin and the carbon enriched material, are enhanced in the agglomerated composite, as particles are present in close proximity to each other. A further advantage is that the tendency for dusting is reduced when lignin is provided in agglomerated form.

The use of a carbon enriched material together with lignin, as in an agglomerated lignin-carbon composite material, has been found to improve the thermal processability of lignin. The agglomerated lignin-carbon composite material has improved thermal resistance by reducing melting/swelling behaviour upon heating, as compared to lignin that has been agglomerated without the addition of a carbon enriched material. This facilitates and improves the processability of lignin on an industrial scale.

The agglomerated lignin-carbon composite material may comprise at least one additive, or no additives. In the context of the present invention, an additive is a substance that is added to improve either the processability or the functionality of the obtained material. Thus, additives are substances that are added, but that are not present in the lignin starting material. Thus, neither moisture, such as water, nor other components already present in the lignin starting material are considered additives in the context of the present invention. The recirculated carbon enriched material is not considered an additive in the context of the present invention.

The total amount of additive(s) is preferably less than 5 wt %, such as from 0 to 5 wt %, or from 0.1 to 5 wt %, or less than 2 wt %, such as from 0 to 2 wt %, or from 0.1 to 2 wt %, as based on the total dry weight of the agglomerated lignin-carbon composite material. The agglomerated lignin-carbon composite material thus comprises at least 95 wt %, such as at least 98%, of lignin and carbon enriched material, as based on the total dry weight of the agglomerated lignin-carbon composite material.

In embodiments where the agglomerated lignin-carbon composite material comprises at least one additive, the additive(s) may be added to the lignin-carbon mixture at any time. The additive(s) may also be added to lignin or to the recirculated carbon enriched material fraction prior to lignin being mixed with the recirculated carbon enriched material fraction. The additive(s) may also be added at any stage during forming of the agglomerated lignin-carbon composite material. Any suitable additives, such as binders or lubricants, may be added to facilitate the subsequent compaction process and to improve the density and mechanical properties of the obtained lignin-carbon composite material. In addition, additives having an influence on the properties of the final material may be added, such as functionality-enhancing additives.

The agglomerated lignin-carbon composite material may be formed by any suitable method. For example, the lignin-carbon composite material may be formed by compaction of a dry lignin-carbon mixture and crushing of the compacted material, or by means of e.g. a pellet press.

In a preferred embodiment, the agglomerated lignin-carbon composite material is formed by a process involving compaction and crushing. The step of forming the agglomerated lignin-carbon composite material may comprise the steps of:
optionally drying the lignin-carbon mixture;
compacting the lignin-carbon mixture so as to obtain a lignin-carbon composite material; and
crushing the lignin-carbon composite material so as to obtain an agglomerated lignin-carbon composite material.

The first step of forming agglomerated lignin-carbon composite material involves optionally drying the lignin-carbon mixture. In embodiments where the recirculated carbon enriched material fraction is mixed with lignin in a solution or in a slurry, the lignin-carbon mixture must be dried prior to compacting the lignin-carbon mixture. Also in embodiments where the recirculated carbon enriched material fraction is mixed with lignin in the form of a powder, the lignin-carbon mixture may be dried prior to compaction. Preferably, the moisture content of the lignin-carbon mixture is less than 45 wt %, or less than 25 wt %, or less than 10 wt %, or less than 8 wt % prior to compacting the lignin-carbon mixture. Preferably, the moisture content is at least 1 wt %, such as at least 5 wt %. Drying is performed using methods and equipment known in the art. The temperature during the drying is preferably in the range of from 80 to 160 °C, more preferably in the range of from 100 to 120 °C. The lignin-carbon mixture may also be pulverized prior to compacting.

The second step of forming agglomerated lignin-carbon composite material involves compacting the lignin-carbon mixture so as to obtain a lignin-carbon composite material. Since the lignin-carbon mixture has been dried prior to compaction, the lignin-carbon mixture is preferably in powder form at the start of the compaction. The compaction of the lignin-carbon powder mixture is preferably carried out by roll compaction. The roll compaction of the lignin-carbon powder mixture can be achieved by a roller compactor to press the lignin-carbon powder mixture into a composite material.

In the compaction step, a compacted lignin-carbon composite material is generated. Here, the lignin-carbon powder mixture is usually fed through a hopper and conveyed by means of a horizontal or vertical feeding screw into the compaction zone where the material is compacted into flakes by compaction rollers with a defined gap. By controlling the feeding screw speed, and the pressure development in the compaction zone, flakes with uniform density can be obtained. The pressure development in the compaction zone can preferably be monitored and controlled by the rotational speed of the compaction rolls. As the powder is dragged between the rollers, it enters what is termed as the nip area where the density of the material is increased and the powder is converted into a flake or ribbon. The rolls used have cavities. The depth of each cavity used in the roll compaction is from 0.1 mm to 10 mm, preferably from 1 mm to 8 mm, more preferably from 1 mm to 5 mm or from 1 mm to 3 mm. The specific press force exerted during the compaction may vary depending on the equipment used for compaction, but may be in the range of from 1 kN/cm to 100 kN/cm. Equipment suitable for carrying out the compaction are known in the art.

In a preferred embodiment, the temperature of the lignin-carbon powder mixture is kept below 150 °C, such as below 100 °C, during the compaction process.

In one embodiment of the roll compaction, the roll configuration is such that the first roll has an annual rim in such configuration so that the lignin-carbon powder mixture in the nip region is sealed in the axial direction along the roller surface.

In one embodiment, the roll configuration is such that the nip region is sealed in the axial direction along the roller surface with a static plate. By ensuring that the nip region is sealed, loss of lignin-carbon powder at the axial ends of the rollers is minimized as compared to entirely cylindrical nip rollers.

During compaction, a lignin-carbon composite material is formed as the lignin particles and carbon enriched material particles are pressed together by mechanical pressure. The dispersion of the carbon enriched material and lignin is improved as the particles of the respective powders are pressed into close proximity of each other. It has been found that the carbon enriched material can facilitate the compaction process by reducing internal friction between the lignin particles.

The compaction may also act to enhance the interactions between the lignin particles and the carbon enriched material in the composite, due to primary particle re-arrangement and plastic deformation induced by the mechanical force. The compaction will further act to ensure that the uniform distribution achieved in the mixing step is maintained until the lignin-carbon composite material can be further stabilized, i.e. by a thermal stabilization step.

Compaction may be carried out on a lignin-carbon powder mixture with no additives added. Alternatively, it may be carried out on a lignin-carbon powder mixture also comprising small amounts of at least one additive, such as less than 5 wt %, or less than 2 wt %, as based on the total dry weight of the lignin-carbon powder mixture.

The second step of forming agglomerated lignin-carbon composite material involves crushing the lignin-carbon composite material so as to obtain an agglomerated lignin-carbon composite material. In the crushing step, the compacted lignin-carbon composite from the compaction step is subjected to crushing or grinding, such as by means of rotary granulator, cage mill, beater mill, hammer mill or crusher mill and/or combinations thereof. During this step, an agglomerated lignin-carbon composite material is generated, as the compacted lignin-carbon composite material is crushed into agglomerates.

After crushing, the crushed material is preferably subjected to a sieving step, to remove fine material, which may be recirculated back to the compaction step. In addition, large material, such as agglomerates having a diameter larger than 2.0 mm or 5.0 mm, may be removed and/or recirculated back to the crushing step.

In the sieving step, the agglomerated lignin-carbon composite material from the crushing step is screened by means of physical fractionation such as sieving, also referred to as screening, to obtain a product which is an agglomerated lignin-carbon composite material with a defined particle size set by the pore size of the sieves or screens in this step. The sieve or screen is selected such that most particles having a diameter below 50 μm, or below 200 μm, or below 500 μm, pass through the screen and are rejected and preferably returned to the compaction step, whereas most particles having a diameter above 50 μm, or above 200 μm, or above 500 μm are retained and subjected to the subsequent steps of the process according to the present invention. The sieving may be carried out in more than one step, i.e. the sieving can be carried out such that the crushed material from the crushing step passes sequentially through more than one screen, sieve or classifier.

During the process of compaction, the bulk density of the material is increased as the material is pressed tightly together. In one embodiment, the bulk density of the agglomerated lignin-carbon composite material is in the range of from 0.5 to 0.8 g/cm³. Due to the compaction of the lignin-carbon powder mixture during preparation of an agglomerated lignin-carbon composite material, the bulk density of the lignin-carbon powder mixture will increase as pressure is applied to the powder. This means that the agglomerated lignin-carbon composite material will have a higher bulk density than the lignin-carbon powder mixture. A more compact material may be beneficial during subsequent processing to carbon enriched materials, as an agglomerated lignin-carbon composite material have been found to retain its shape and dimensions with no melting or swelling. The agglomerated lignin-carbon composite material will also have a relatively higher hardness after compaction. Hard agglomerates are advantageous during subsequent processing as they can resist physical impact during processing. As discussed above, the carbon enriched material will also improve the thermal processability of lignin.

In a preferred embodiment, the method according to the first aspect comprise an additional step of pre-heating the agglomerated lignin-carbon composite material to a temperature in the range of from 140 to 300 °C for a period of at least 30 minutes so as to obtain a thermally stabilized agglomerated lignin-carbon composite material.

The term “thermally stabilized” as used herein, refers to a material obtained by a process of pre-heating the agglomerated lignin-carbon composite material at a temperature lower than the temperature required for carbonization. By performing such a pre-heating, which may also be referred to as a thermal stabilization, the obtained thermally stabilized agglomerated lignin-carbon composite material can be heat treated at higher temperatures with retained shape and dimension, avoiding melting/swelling and deformation during the subsequent carbonization. The thermally stabilized agglomerated lignin-carbon composite material is cross-linked. In one embodiment, the pre-heating is carried out in an oxidative atmosphere.

Cross-linking of lignin will occur during the pre-heating due to both oxidative and thermal effects. The cross-linking is facilitated by the combined oxidative and thermal effects. Due to the cross-linking, lignin within the agglomerates will become hard and not melt/swell during the subsequent carbonization. Prior to pre-heating, the lignin agglomerates behave as a thermoplastic material, whereas after thermal stabilization, the lignin agglomerates instead behave as a thermoset material.

Oxidative species that can react so as to cross-link lignin are present in such oxidative atmosphere. The pre-heating may be carried out for example in the presence of oxygen, iodine, ozone, nitrogen dioxide, nitrobenzene, hydrogen peroxide and peracetic acid. Preferably, the heating is carried out in air. Alternatively, any suitable oxidative species may be supplied in a nitrogen atmosphere.

Preferably, the pre-heating is carried out such that the agglomerated lignin-carbon composite material is completely thermally stabilized, i.e. completely cross-linked. The term “completely thermally stabilized” as used herein, refers to agglomerated lignin-carbon composite material that has been thermally stabilized to an extent that the same degree of cross-linking is achieved all through the material. This means that the material properties, such as structure and hardness, will be the same throughout the entire completely thermally stabilized agglomerated lignin-carbon composite material. For example, the core of the completely thermally stabilized agglomerated lignin-carbon composite material will have the same hardness and the same degree of cross-linking as the shell. The completely thermally stabilized agglomerated lignin-carbon composite material is thus homogenous in structure. A completely thermally stabilized agglomerated lignin-carbon composite material may be obtained by providing agglomerated lignin-carbon composite material of a relatively small size, such as having an average particle size in the range of from 50 μm to 1.0 mm, and/or by pre-heating the agglomerated lignin-carbon composite material for a sufficient amount of time.

The pre-heating is carried out such that the agglomerated lignin-carbon composite material is heated to a temperature in the range of from 140 to 300 °C, preferably from 180 to 260 °C. The pre-heating is carried out for at least 30 minutes, i.e. the residence time of the agglomerated lignin inside the equipment used for the pre-heating is at least 30 minutes. In one embodiment, the pre-heating is carried out for at least 1 hour, or at least 1.5 hours. Preferably, the pre-heating is carried out for less than 12 hours. The pre-heating may be carried out at the same temperature throughout the entire pre-heating stage or may be carried out at varying temperature, such as a stepwise increase of the temperature or using a temperature gradient. More preferably, the pre-heating is carried out such that the agglomerated lignin-carbon composite material is first heated to a temperature in the range of from 140 to 175 °C for a period of at least 15 minutes and subsequently heated to a temperature in the range of from 175 to 300 °C for at least 15 minutes.

The thermal processability of lignin is improved by the combination of providing lignin in the form of agglomerated lignin, by mixing lignin with a carbon enriched material so that a lignin-carbon composite material is obtained, and by performing a pre-heating so that the lignin is thermally stabilized. Thus, the thermally stabilized agglomerated lignin-carbon composite material can be subjected to further heat treatments in order to carbonize the material, with no melting/swelling behaviour. This improves the processability on an industrial scale. Depending on the amount and particle size distribution of the carbon enriched material present in the agglomerated lignin-carbon composite material, sufficient processability may be obtained also without pre-heating.

Step d) of the method according to the first aspect of the present invention relates to subjecting the agglomerated lignin-carbon composite material to heat treatment at one or more temperatures in the range of from 300 to 1500 °C, wherein the heat treatment is carried out for a total time in the range of from 30 minutes to 10 hours, so as to obtain a carbon enriched material. In embodiments where the agglomerated lignin-carbon composite material has been subjected to pre-heating such that a thermally stabilized agglomerated lignin-carbon composite material has been obtained, it is the thermally stabilized agglomerated lignin-carbon composite material that is subjected to heat treatment.

The term “heat treatment” as used herein, refers to a process of heating the agglomerated lignin-carbon composite material at one or more temperatures and for a sufficient time so that the lignin in the composite material is converted to a carbon enriched material. The process may also be referred to as carbonization or calcination. After heat treatment, the carbon content of the material is higher than 80 wt %, or higher than 90 wt %, or higher than 95 wt %, or higher than 98 wt %. Depending on the temperature during the heat treatment, different types of carbon, such as charcoal or hard carbon, can be obtained from lignin.

The term “carbon enriched material” as used herein, refers to a carbon material obtained by heat treatment of lignin. The carbon content of the carbon enriched material is higher than 80 wt %, or higher than 90 wt %, or higher than 95 wt %, or higher than 98 wt %. The carbon enriched material may also comprise for example heteroatoms, such as O and N, inorganic impurities, and functional additives. The carbon enriched material of the present invention is an amorphous (i.e. non-crystalline) carbon, preferably hard carbon. The carbon enriched material obtained in step d) of the method according to the first aspect comprises both recirculated carbon enriched material and carbon enriched material obtained by heat treatment of lignin, where the recirculated material comprises carbon enriched material obtained in a previous heat treatment of lignin. Once the lignin has been fully converted to a carbon enriched material (e.g. at a temperature of at least about 1000 °C), it is not possible to distinguish recirculated carbon enriched material from the freshly obtained carbon enriched material.

The heat treatment may be carried out at the same temperature throughout the entire heat treatment or may be carried out at varying temperature, such as a stepwise increase of the temperature or using a temperature gradient. The heat treatment may comprise a temperature ramp from a starting temperature to a target temperature. The heating rate may be 1-100 °C/min. For example, the heat treatment may involve several intermediate temperatures, with temperature ramps in between them, before reaching the target temperature needed for carbonization of the agglomerated lignin-carbon composite material. The heat treatment may be carried out as a batch process or a continuous process. Any suitable reactor can be used, such as rotary kiln, moving bed furnace, pusher furnace or rotary hearth furnace. The heat treatment is preferably carried out under inert atmosphere, preferably nitrogen atmosphere.

Preferably, the heat treatment comprises a preliminary heating step, preferably followed by a final heating step. The preliminary heating step is preferably carried out at one or more temperatures in the range of from 300 to 800 °C, such as from 500 to 700 °C. The preliminary heating step is preferably carried out under inert atmosphere, preferably nitrogen atmosphere. The duration of the preliminary heating step is at least 30 minutes and preferably less than 10 hours. The surface area of the carbon enriched material obtained after the preliminary heating step is typically in the range of from 300 to 700m²/g, measured as BET using nitrogen gas. The final heating step is preferably carried out at one or more temperatures in the range of from 800 to 3000 °C. The final heating step is preferably carried out under inert atmosphere, preferably nitrogen atmosphere. The duration of the final heating step is at least 30 minutes and preferably less than 10 hours. After the final heating step carried out at 1000 °C or higher, the surface area of the carbon enriched material obtained is typically 50m²/g or less.

The preliminary and final heating steps may be carried out as discrete steps or as one single step in direct sequence. The preliminary and final heating steps may involve heating at one or more temperatures, as discussed above for the heat treatment. For example, the preliminary heating starts at about 300 °C and the temperature is subsequently increased to about 500 °C. The final heating step is preferably carried out between 900 and 1300 °C, such as at about 1000 °C.

The conversion of lignin to a carbon enriched material starts at about 250 °C. The amount of lignin converted to carbon depends primarily on the temperature and time used during the heat treatment. The properties of the obtained carbon enriched material also depend on the temperature and time used during the heat treatments. Thus, the carbon enriched material obtained after the preliminary heating step may be different in some aspects from the carbon enriched material obtained after the final heating step. For example, the carbon content may be higher after the final heating step, and the structure of the carbon in the carbon enriched material may be different.

The preliminary and final heating steps may be carried out as batch processes or as continuous processes. Any suitable reactors can be used. The preliminary heating step and the final heating step can be carried out in the same reactor or in separate reactors.

The carbon enriched material preferably has a bulk density in the range of from 0.2 g/cm³ to 0.4g/cm³. This is lower than the bulk density of the agglomerated lignin-carbon composite material, primarily due to mass loss during the heat treatments.

The obtained carbon enriched material preferably has a helium true density in the range of from 1.4 to 2.1g/cm³, such as from 1.7 to 2.0g/cm³. The helium true density may be determined using a pycnometer, as known by a person skilled in the art. It is important to have a helium true density in the range of from 1.4 to 2.1 g/cm³ as the doping and de-doping capacity of the carbon enriched material when used as the active material in the negative electrode of a non-aqueous secondary battery may otherwise be reduced, and the irreversible capacity of the battery may become large. If the density of the carbon enriched material is too low, the energy density of the electrode may also be decreased.

By providing lignin in agglomerated form, and by mixing lignin with the recirculated carbon enriched material fraction, it is ensured that lignin does not melt/swell during the heat treatments carried out to convert it to a carbon enriched material. By carrying out a pre-heating step prior to the heat treatment, the dimensional stability of lignin may be further improved, thus reducing the risk of melting/swelling further. Depending on the amount of recirculated carbon enriched material mixed with lignin, and also the particle size distribution of the recirculated fraction, pre-heating may not be necessary to reduce the melting/swelling of lignin during the heat treatment.

Step e) of the method according to the first aspect of the present invention involves milling the obtained carbon enriched material to so as to reduce the average particle size of the carbon enriched material, and to obtain at least a first fraction of carbon enriched material and a second fraction of carbon enriched material. Milling may be carried out using any suitable equipment, such as using a cutting mill, blade mixer, ball-mill, impact mill, hammer mill and/or jet-mill. Milling may also be referred to as for example pulverization, crushing or grinding. The first fraction of carbon enriched material may have a first average particle size, and the second fraction of carbon enriched material may have a second average particle size.

The first fraction of carbon enriched material may have an average particle size in the range of from 1 to 100 μm, or from 1 to 80 μm, or from 1 to 50 μm, or from 1 to 20 μm. The second fraction of carbon enriched material may have an average particle size in the range of from 1 to 100 μm, or from 1 to 80 μm, or from 1 to 50 μm, or from 1 to 20 μm.

The average particle sizes of the first and second fractions of carbon enriched material may be the same or be different. For example, the first average particle size may be smaller than the second average particle size.

The first fraction may be separated from the second fraction by any suitable means, such as classification and/or sieving. Such processes may be carried out subsequently to milling, and/or during milling. Suitable equipment that may be used for separation of the first fraction from the second fraction includes air-classifier equipment such as gravitational, centrifugal, cyclonic and/or gyrator air-classifier systems, and sieving equipment such as tumbling and/or vibrating screening instruments. The separation may be carried out in several steps.

The obtained carbon enriched material is milled in order to reduce the average particle size, which facilitates the use of the carbon enriched material as active material in a negative electrode of a secondary battery. During milling, particles with sizes in a large span are created. Typically, particles with a small particle size (often referred to as carbon fines), are removed and discarded, whereas particles having a size in the desired range are further processed. However, in some applications it is also of interest to utilize particles with a small particle size, such as carbon fines. For example, the electrode density may be improved by using an active material of small particle size. In addition, the charge/discharge rate performance of an electrode may be improved due to faster metal diffusion when using an active material of small particle size. Thus, the particle sizes of the first fraction and the second fraction are selected depending on the end use of the carbon enriched material produced by the method according to the present invention.

In one preferred embodiment, the first fraction of carbon enriched material has an average particle size in the range of from 1 to 4 μm. This corresponds to carbon fines. By recirculating the carbon fines, the material waste of the process is reduced as the carbon fines would otherwise be discarded. A more sustainable process is thus enabled, while also improving the thermal processability of the agglomerated lignin-carbon composite material. The second fraction of carbon enriched material may in such embodiments have an average particle size in the range of from 4 to 100 μm, or from 4 to 80 μm, or from 4 to 50 μm or from 4 to 20 μm. Such fractions may be obtained for example by carrying out simultaneous milling and classification, such that most particles with a size of less than 100 μm, or less than 80 μm, or less than 50 μm, or less than 20 μm will pass through a first classifying unit. Particles with a larger size remain in the milling unit until the size has been further reduced. The particles that have passed through the first classifying unit are further classified in a second classifying unit, where the first fraction is separated from the second fraction. Here, the first fraction of carbon enriched material, having a small average particle size, such as below 4 μm, passes through the classification unit and are recirculated. The second fraction of carbon enriched material with a larger average particle size, such as above 4 μm, may continue to the subsequent process steps, or may alternatively be collected as the end product.

In another embodiment, the first fraction of carbon enriched material may have an average particle size in the range of from 1 to 100 μm, or from 1 to 80 μm, or from 1 to 50 μm or from 1 to 20 pm. The second fraction of carbon enriched material may also have an average particle size in the range of from 1 to 100 μm, or from 1 to 80 μm, or from 1 to 50 μm or from 1 to 20 μm. Thus, in such embodiments the first and second fractions may comprise carbon enriched materials having the same average particle sizes. Carbon fines may thus be included in both the first and second fractions. Recirculation is in this embodiment thus not performed in order to decrease the material loss of the process, but to improve the processability of the obtained agglomerated lignin-carbon composite material.

In another embodiment, the first fraction of carbon enriched material may have an average particle size in the range of from 4 to 100 μm, or from 4 to 80 μm, or from 4 to 50 μm or from 4 to 20 μm, such that carbon fines are present mainly in the second fraction. In such embodiments, the second fraction of carbon enriched material may have an average particle size in the range of from 1 to 20 μm. In such embodiments, the recirculated fraction may comprise carbon enriched material of an average particle size that is larger than that of the end product. If the desired average particle size of the end product is small, such as in the range of from 1 to 5 μm, extensive milling, leading to high energy consumption, is required in order for all the carbon enriched material to reach the desired particle size. If sufficient milling is not possible, for example due to limitation on the equipment, the carbon enriched material of a too large particle size would be discarded. By instead recirculating the carbon enriched material of larger particle size, as in the inventive method, less milling is required and energy consumption is reduced while also reducing material loss. In addition, recirculating carbon enriched material improves the thermal processability of the obtained agglomerated lignin-carbon composite material as discussed above.

In embodiments where the heat treatment in step d) comprises a preliminary heating step followed by a final heating step, the step of milling is preferably carried out after the preliminary heating step and prior to the final heating step. The first fraction may thus be recirculated after the preliminary heating step, whereas the second fraction is subjected to the final heating step.

Step f) of the method according to the present invention involves recirculating at least a part of the first fraction obtained in step e) to step b). For example, at least 80% of the first fraction is recirculated. Preferably, at least 90% is recirculated, and more preferably at least 98% is recirculated. This means that preferably the entire first fraction is recirculated back such that it is mixed with lignin. In embodiments where the first fraction would otherwise be discarded, recirculating the entire first fraction, or a large part of the first fraction, enables a more sustainable process since the material loss is reduced. The yield is also improved since all, or almost all, lignin entering the process will be converted to carbon and constitute the end product.

The method according to the present invention may be a batch process or a continuous process. In a batch process, recirculation involves collecting the first fraction and storing it until it is subsequently mixed with lignin in a following batch. In a continuous process, the first fraction collected after the milling step is continuously recirculated back to the mixing step where it is introduced into a lignin process stream.

In a preferred embodiment, the heat treatment comprises a preliminary heating step and a final heating step, and milling is carried out after the preliminary heating step and prior to the final heating step. In such embodiments, the first fraction is preferably recirculated after the preliminary heating step, whereas the second fraction is subjected to the final heating step.

During heat treatment, the lignin is converted to a carbon enriched material. The properties of the carbon enriched material depend on for example the temperature and time of the heat treatment. Heating at high temperatures, such as above 1000 °C, results in a hard material. Thus, the carbon enriched material obtained after the final heating step is harder than the carbon enriched material obtained after the preliminary heating step, due to temperature-dependent changes in the structure of carbon during heat treatment. It has been found that when milling is carried out after the preliminary heating step, and the obtained first fraction is recirculated prior to the final heating step, mixing of the recirculated fraction with lignin is facilitated due to the carbon enriched material in the recirculated fraction being softer. In addition, the formation of the agglomerated lignin-carbon composite material is facilitated, since interactions between lignin and the carbon enriched material are improved.

Thus, in a preferred embodiment, the method according to the present invention comprises the following steps:
a) providing lignin;
b) mixing the lignin with a recirculated carbon enriched material fraction so as to obtain a lignin-carbon mixture;
c) forming an agglomerated lignin-carbon composite material comprising the lignin, the recirculated carbon enriched material fraction and optionally at least one additive;
d) optionally pre-heating the agglomerated lignin-carbon composite material to a temperature in the range of from 140 to 300 °C for a period of at least 30 minutes so as to obtain a thermally stabilized agglomerated lignin-carbon composite material;
e) subjecting the agglomerated lignin-carbon composite material or the thermally stabilized agglomerated lignin-carbon composite material to a preliminary heating step at one or more temperatures in the range of from 400 and 800 °C for at least 30 minutes, so as to obtain a carbon enriched material;
f) milling the obtained carbon enriched material so as to reduce the average particle size of the carbon enriched material, and to obtain at least a first fraction of carbon enriched material, and a second fraction of carbon enriched material; and
g) recirculating at least a part of the first fraction obtained in step f) to step b);
h) subjecting the second fraction obtained in step f) to a final heating step at one or more temperatures in the range of from 800 to 1500 °C for at least 30 minutes.

### EXAMPLES

### Example 1

Lignin powder (softwood kraft lignin) from the LignoBoost process was mixed together with 5 wt % of a carbon enriched material powder using a conical screw mixer (200 RPM, 15 minutes). The carbon enriched material powder was recirculated from a previous batch where agglomerated lignin was heated at 500 °C for 1 h in a nitrogen atmosphere followed by pulverization to a Dᵥ₅₀ of 5 μm. No other additives were added. The mixture was then compacted by means of roller compaction using a Lab Compactor at 50 kN to obtain a composite material, which was subsequently crushed using a Flake crusher and sieved into agglomerates with a particle size distribution of from 0.5 to 1.5 mm.

The agglomerated lignin-carbon composite was further thermally stabilized by heating inside a rotary kiln to 235 °C for 2 h in air. During this process, the agglomerated lignin did not exhibit any melting behaviour and retained its original shape. It was found that the individual agglomerates did not fuse together and remained free flowing. The material gradually darkened during the processing until it was completely black and free of smell.

This thermally stabilized agglomerated lignin-carbon composite material was subsequently heat treated at 500 °C during 1 h under inert atmosphere, to carbonize the material. This yielded a granular carbon-carbon composite material without any melting or fusing of granules and with retained shape/size as compared to the thermally stabilized agglomerated lignin-carbon composite material prior to carbonization.

In view of the above detailed description of the present invention, other modifications and variations will become apparent to those skilled in the art. However, it should be apparent that such other modifications and variations may be effected without departing from the spirit and scope of the invention.

1. A method for producing a carbon enriched material, said method comprising the steps of:
a) providing lignin;
b) mixing the lignin with a recirculated carbon enriched material fraction so as to obtain a lignin-carbon mixture;
c) forming an agglomerated lignin-carbon composite material comprising the lignin, the recirculated carbon enriched material fraction and optionally at least one additive;
d) subjecting the agglomerated lignin-carbon composite material to heat treatment at one or more temperatures in a range of from 300 to 1500 °C, wherein the heat treatment is carried out for a total time in a range of from 30 minutes to 10 hours, so as to obtain a carbon enriched material;
e) milling the carbon enriched material so as to reduce an average particle size of the carbon enriched material, and to obtain at least a first fraction of carbon enriched material, and a second fraction of carbon enriched material; and
f) recirculating at least a part of the first fraction of carbon enriched material obtained in step e) as the recirculated carbon enriched material fraction of step b).

2. The method according to claim 1, wherein the lignin is kraft lignin.

3. The method according to claim 1, wherein the lignin provided in step a) comprises a powder.

4. The method according to claim 1, wherein the lignin provided in step a) comprises a slurry.

5. The method according to claim 1, wherein the lignin provided in step a) is dissolved in a solution.

6. The method according to claim 1, wherein the first fraction of carbon enriched material has an average particle size in a range of from 1 to 100 μm.

7. The method according to claim 1, wherein the first fraction of carbon enriched material has an average particle size in a range of from 1 to 4 μm.

8. The method according to claim 1, wherein the agglomerated lignin-carbon composite material comprises, based on a total weight of the agglomerated lignin-carbon composite material, from 1 to 50 wt % of recirculated carbon enriched material; from 50 to 99 wt % lignin; and optionally less than 5 wt % of at least one additive.

9. The method according to claim 1, wherein the step of forming the agglomerated lignin-carbon composite material comprises:
optionally drying the lignin-carbon mixture;
compacting the lignin-carbon mixture so as to obtain a lignin-carbon composite material; and
crushing the lignin-carbon composite material so as to obtain the agglomerated lignin-carbon composite material.

10. The method according to claim 1, further comprising:
pre-heating the agglomerated lignin-carbon composite material to a temperature in a range of from 140 to 300 °C for a period of at least 30 minutes so as to obtain a thermally stabilized agglomerated lignin-carbon composite material.

11. The method according to claim 10, wherein the pre-heating is carried out in an oxidative atmosphere.

12. The method according to claim 10, wherein the pre-heating comprises first heating the agglomerated lignin-carbon composite material to a temperature in a range of from 140 to 175 °C for a period of at least 15 minutes, and subsequently heating the agglomerated lignin-carbon composite material to a temperature in a range of from 175 to 300 °C for at least 15 minutes.

13. The method according to claim 1, wherein the heat treatment in step d) is carried out in an inert atmosphere.

14. The method according to claim 1, wherein the heat treatment in step d) comprises a preliminary heating step, followed by a final heating step.

15. The method according to claim 14, wherein the preliminary heating step is carried out at a temperature between 400 and 800 °C for at least 30 minutes.

16. The method according to claim 14, wherein the final heating step is carried out at a temperature between 800 and 1500 °C for at least 30 minutes.

17. The method according to claim 14, wherein the step of milling is carried out after the preliminary heating step and prior to the final heating step.

18. The method according to claim 17, wherein at least a part of the first fraction of carbon enriched material is re-circulated prior to the final heating step.

19. A negative electrode for a non-aqueous secondary battery comprising:
the carbon enriched material obtained the method according to claim 1 as an active material.

20. (canceled)
